(19) United States
(12) Patent Application Publication
(10) Pub. No.: US 2008/0163307 A1
(43) Pub. Date: Jul. 3, 2008

(54) DIGITAL CONTENT ACCESS

(76) Inventors: Matthew J. Coburn, Denver, CO (US); LeRoy Ellis, Parker, CO (US); Chris Michaelson, Castle Rock, CO (US); Daniel L. Rudolph, Castle Rock, CO (US); Jiang Xu, Aurora, CO (US); Ting Yuan, Greenwood Village, CO (US)

Correspondence Address: EchoStar Technologies, L.L.C., c/o Dorsey & Whitney LLP, 370 Seventeenth St, Suite 4700, Denver, CO, 80202, US

(21) Appl. No.: 11/618,540

(22) Filed: Dec. 29, 2006

(51) Int. Cl. H04N 5/445

(52) U.S. Cl. 725/61

(57) ABSTRACT

A system for accessing entertainment options includes a graphic user interface generator that generates program listing display data to display a listing of programs available for downloading to a user on an associated display device. A user may select one or more programs from the listing displayed on the associated display device using the user access device, thereby initiating download of the selected program by the communication component. The storage device stores user history data, which is used to generate recommendation display data based upon the recommendation data to enable the user to view and/or select for download recommended programs. The graphic user interface generator may generate download queue data for display on the associated display device, wherein the displayed download queue data enables the user to view and/or edit the current download status of each program to be downloaded. The program data from the remote communication system may include real-time programs broadcast by the remote communication system, program guide data including current and future broadcast program information, and download program data including programs available for download from the remote communication system, which the user may search using the user access device.

### FIELD OF THE INVENTION

The present invention relates to a system for enabling a user to access a plurality of digital content, including the selection, viewing, recording, and downloading of audiovisual and multimedia programs, such as television programs and movies, and access to information, such as electronic program guide information and recommended program information, using a television screen, computer monitor, or other display on which a graphic user interface or series of interfaces may be displayed and a user access device, such as a wireless remote control, by which the user may access the entertainment options provided by the graphic user interface(s).

### BACKGROUND

The proliferation and convergence of digital services and content, and particularly entertainment, has lead to a wide array of options for both receiving and displaying such content and services. Presently, digital services and/or content may be accessed by a user through a number of different devices connected to a number of different networks. If a specific service or content is desired, the user may need to access several different networks through several different devices to locate the content.

Additionally, each device and/or network may present services and content in a different manner. Many devices lack anything but the most basic organization of content and/or services, instead presenting options to a user in a manner that obscures the desired content/service.

Accordingly, there is a need in the art for an improved method and system for accessing digital services and content, including entertainment options.

### BRIEF SUMMARY OF THE INVENTION

A system is provided to enable a user to access a plurality of entertainment options in which a user is presented with one or more graphic user interfaces. The user is able to access various entertainment options using a user access device, such as a remote control. Entertainment options may include selection, viewing, recording, rental, purchase, editing, deleting or other desired functions relating to audiovisual and multimedia programs, such as television programs, movies, and other types of audiovisual programs.

In one embodiment, the system enables a user to access entertainment options using a wireless (e.g., radio frequency or infrared) remote control device, which is used to input the user's desired selections in response to in a series of graphic user interfaces presented to the user. Using the remote control device and the series of graphic user interfaces, the user may access an electronic programming guide providing summary information about programs available for viewing, for example, current and future programs. The user accesses the electronic programming guide (EPG) by transmitting a request for display of the EPG to the system, which generates the appropriate graphic user interface. The user may also access additional program details, such as detailed information about selected programs, or perform searching functions, for example, to find a specific program or channel, by transmitting commands to the system as instructed by the graphic user interface.

In addition to accessing program information in the EPG, the system further enables the user to access menu selections by which the user may access customer support functionality, digital video recording options, program rental and/or purchasing options, as well as options relating to video games and other types of multimedia entertainment. Options may include downloading and/or playing of programs, games, or other multimedia, sorting program listings, editing or deleting programs or program listings, program rental or purchase, searching, for example, by keyword or program theme, and/or any other options as desired by the user and/or implementer of the system.

A system for accessing entertainment options may include a communication component for transmitting and receiving program data to and from a remote communication system; a storage device for storing the program data; a processor; a graphic user interface generator for generating display data to be displayed on an associated display device; and a receiver for receiving input data from a user access device. The program data may include a listing of programs available for downloading to the system from the remote communication system via the communication component. The graphic user interface generator may generate program listing display data to display the listing of programs available for downloading to the user on the associated display device. A user may select one or more programs from the listing displayed on the associated display device using the user access device, thereby initiating download of the selected program by the communication component. The storage device stores user history data, representing, for example, past purchases, past recordings, and past viewing history of the user. The processor generates recommendation data based upon the stored user history data, and the graphic user interface generator generates recommendation display data based upon the recommendation data to enable the user to view and/or select for downloading recommended programs.

The downloaded programs may be rented such that the selected program download is available for viewing by the user for a predetermined period of time or purchased such that the selected program download is available for viewing by the user for an unlimited period of time. The graphic user interface generator may generate rental time display data indicating the amount of viewing time remaining for each rented program download or estimated download time display data indicating an estimated download time for each available program.

An alternative system for accessing entertainment options may include the communication component, storage device, processor, graphic user interface generator for generating display data to be displayed on an associated display device, and receiver for receiving input data from a user access device as described above, wherein the program data includes a listing of programs available for downloading to the system from the remote communication system via the communication component and the graphic user interface generator generates program listing display data to display the listing of programs available for downloading to the user on the associated display device. A user may select one or more programs from the listing displayed on the associated display device using the user access device, thereby initiating download of the selected program by the communication component. The graphic user interface generator generates download queue data for display on the associated display device, such that the displayed download queue data enables the user to view a current download status of each program to be downloaded, including queue position, estimated download time, and/or time remaining for ongoing downloads. The user may be able to change the download queue order of one or more programs to be downloaded using the user access device.

The user also may be able to access content and other information about any of the programs available for downloading by selecting or highlighting a program from the listing displayed on the associated display device using the user access device, whereupon the content and other information is automatically displayed.

Another alternate system for accessing entertainment options may include a communication component for transmitting and receiving program data to and from a remote communication system, wherein the program data includes real-time programs broadcast by the remote communication system, program guide data including current and future real-time broadcast program information, and download program data including programs available for download from the remote communication system. A storage device may be provided for storing the program guide data and the download program data. A processor and graphic user interface generator also may be provided. A user may search the stored download program data and/or program guide data by entering one or more search criteria into a graphic user interface generated by a graphic user interface generator using the user access device. In one embodiment, the user may enter a keyword, actor name, program title, or program theme as a search criterion. Broadly, any metadata associated with one or more programs or entertainment options may be used as a search criterion.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 provides a diagram of the components of an exemplary system for accessing entertainment options.

FIG. 1A provides a functional block diagram of an exemplary method for accessing entertainment options performed by the system of FIG. 1.

FIG. 2 provides a diagram of an exemplary user access device for use in the system of FIG. 1.

FIG. 3 depicts an exemplary graphic user interface of a “Main Menu” that may be displayed as part of the user interface of the system of FIG. 1.

FIGS. 4-12B depict exemplary graphic user interfaces through which the functionality of the system of FIG. 1. may be implemented.

### DETAILED DESCRIPTION

A system and method for accessing entertainment options will now be described in detail with reference to the accompanying drawings.

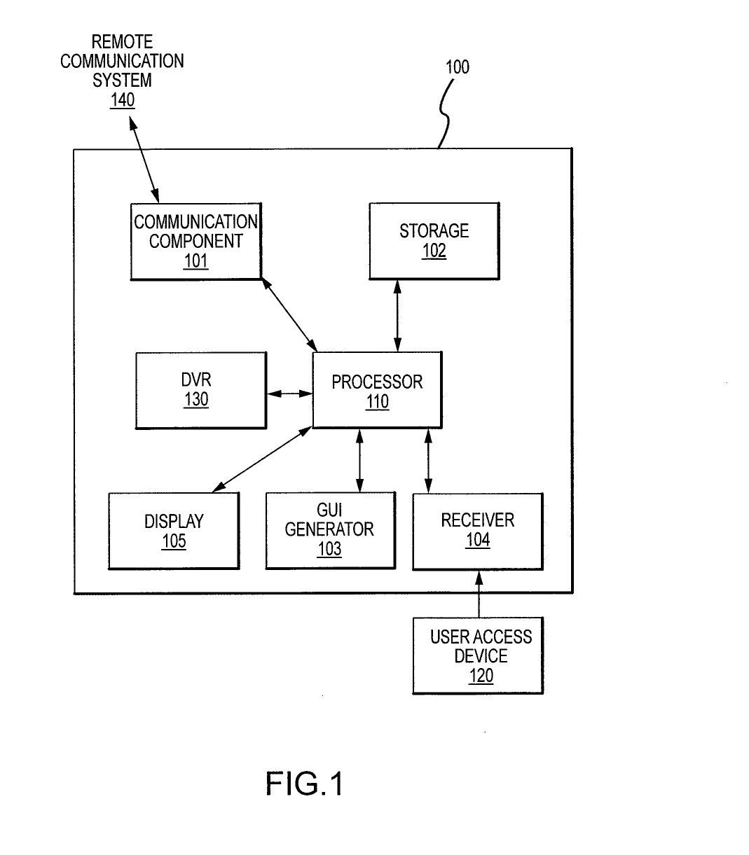

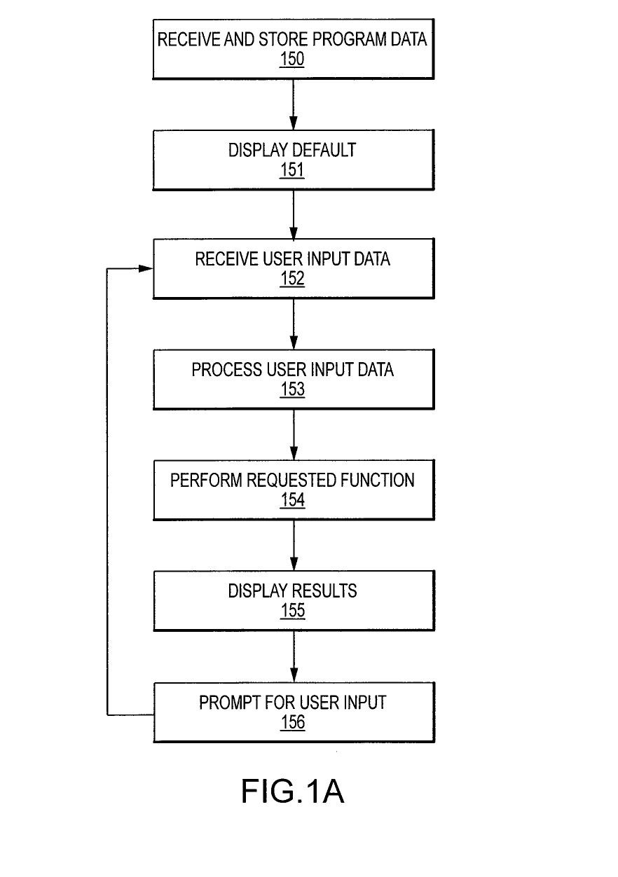

FIG. 1 provides a diagram of an exemplary system 100 for accessing entertainment options. The system 100 includes a communication component 101 for receiving entertainment programs, such as television programs, movies, and other multimedia programs, as well as transmitting and receiving various other types of data to and from a wired or wireless remote communication system 140 provided by, for example, a conventional broadcast television service provider, cable television service provider, satellite television service provider, Internet or IP-based service provider, or other type of service provider or combination of service providers. The communication component may be implemented as a satellite transmitter/receiver, cable transmitter/receiver, IP data transmitter/receiver, or any other type of wired or wireless transmitter/receiver that performs the functionality described above.

System 100 further includes one or more storage devices 102 for storing entertainment programs and the various types of data received by the communication component 101, including program guide data and download program data, as well as graphic user interface display data, input data received from one or more users as described below in detail, and any other data needed to support the functionality of the system 100.

System 100 also includes a graphic user interface generator 103, a receiver 104 for receiving input data from one or more user access devices 120, a display 105, and a processor 110 coupled to components 101, 102, 103, 104 and 105 for implementing the functionality of the system 100.

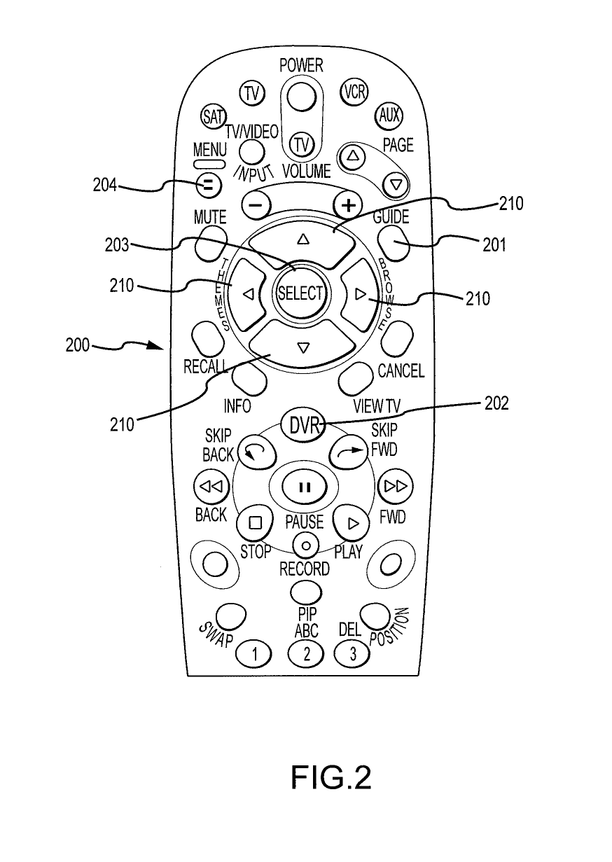

Receiver 104 may be implemented as within communication component 101 or may be implemented as a separate component within system 100 (as shown in FIG. 1). The receiver 104 may be, for example, a radio frequency (RF) or infrared (IR) receiver that receives input data from the user access device 102. The input data is generated when the user enters data, selections, commands, and other inputs into the user access device 120, for example, by pressing various buttons or keys. In one embodiment, the receiver 104 only receives data from the user access device 120, and there is no transmission of data from the system 100 to the user access device 120. In an alternative embodiment, receiver 104 may also act as a transmitter and transmit data, for example, confirmation data, entertainment option data, etc., from the system 100 to the user access device 120, for example, using RF or IR data transmission. The user access device 120 may be a conventional wired or wireless remote control unit (see FIG. 2), or a device that both transmits and receives data from the system 100.

Graphic user interface (GUI) generator 103 generates a user interface for system 100 that enables a user to access a plurality of entertainment options. The GUI generator generates display data that is displayed to a user via display 105. Display 105 may be, for example, a television monitor or screen, computer monitor, or any other type of display device that displays the display data to enable a user to access entertainment options provided by the system 100.

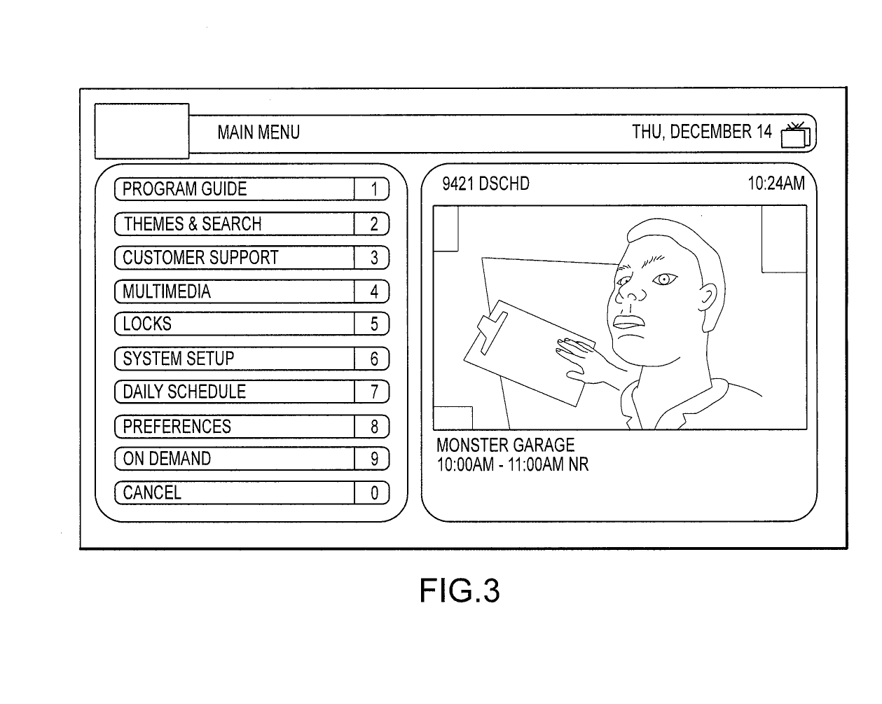

The display data generated by GUI generator 103 may include data concerning entertainment options and programs, for example, received by the system 100 from the remote communication system 140 via communication component 101. Data concerning entertainment programs and options is received by the communication component 101, stored in storage 102, and accessed by the GUI generator 103 by the processor 110 based upon input data received from the user access device 102 by receiver 104. Formatting data used by the GUI generator to generate the display data also may be stored in storage 102 or in the GUI generator 103, and may be updated or otherwise modified by data received from the remote communication system 140 via communication component 101. Display data may include program information, related commands or selection options, setup data, customer service access options, and other types of display data desired by the user and/or implementer of the system 100. Various displays of display data are provided in FIGS. 3-12B, discussed in detail below.

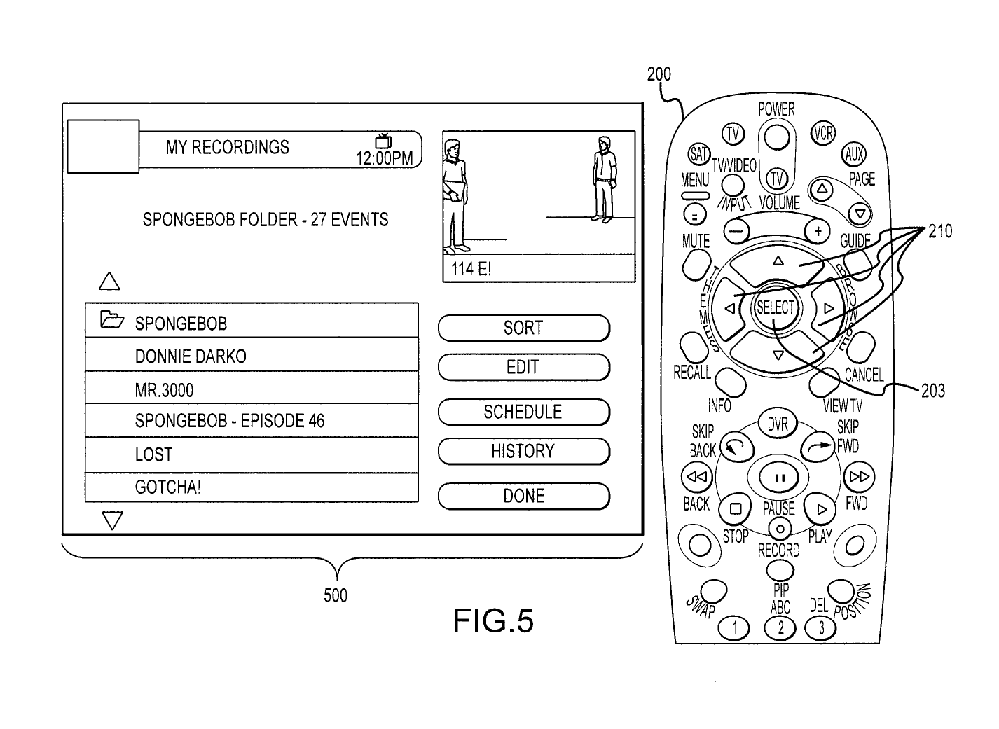

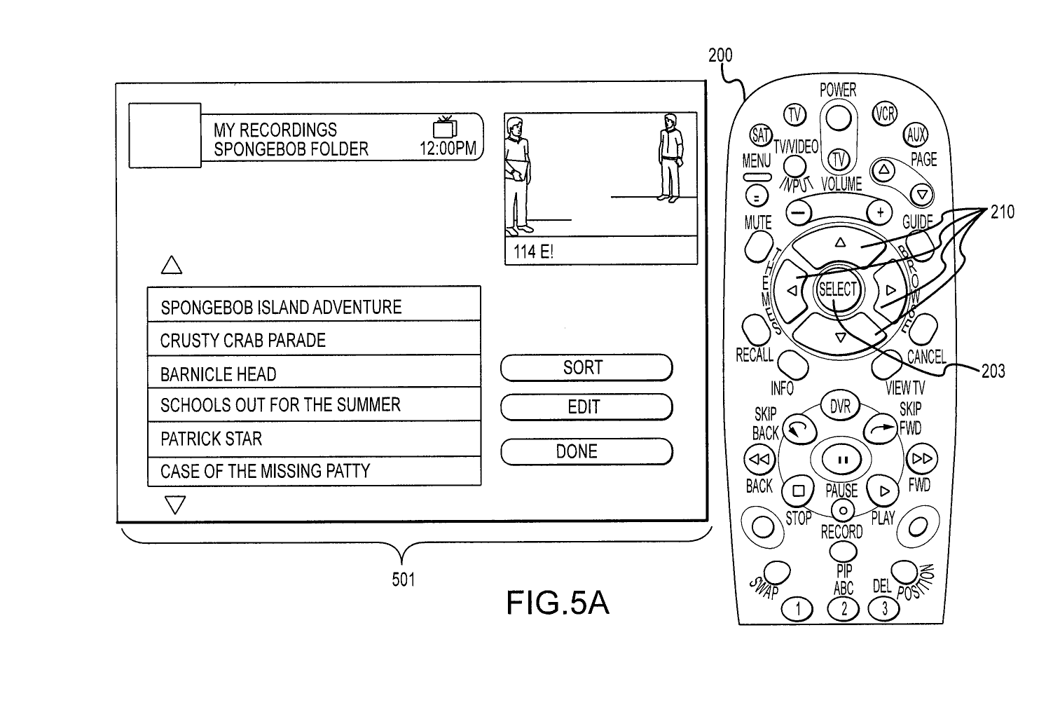

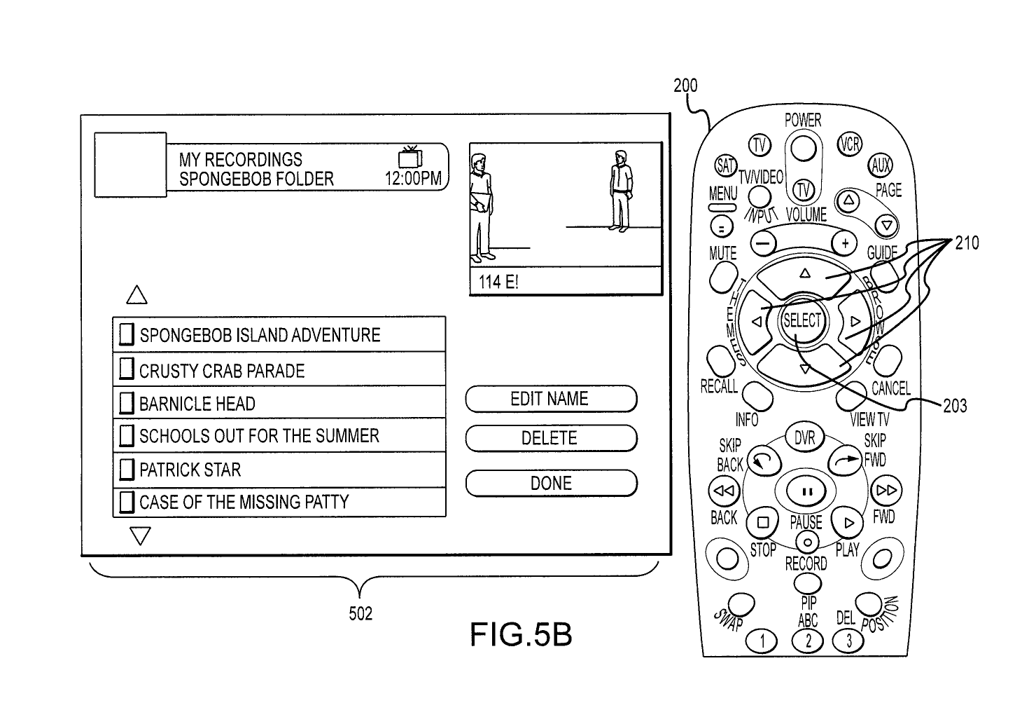

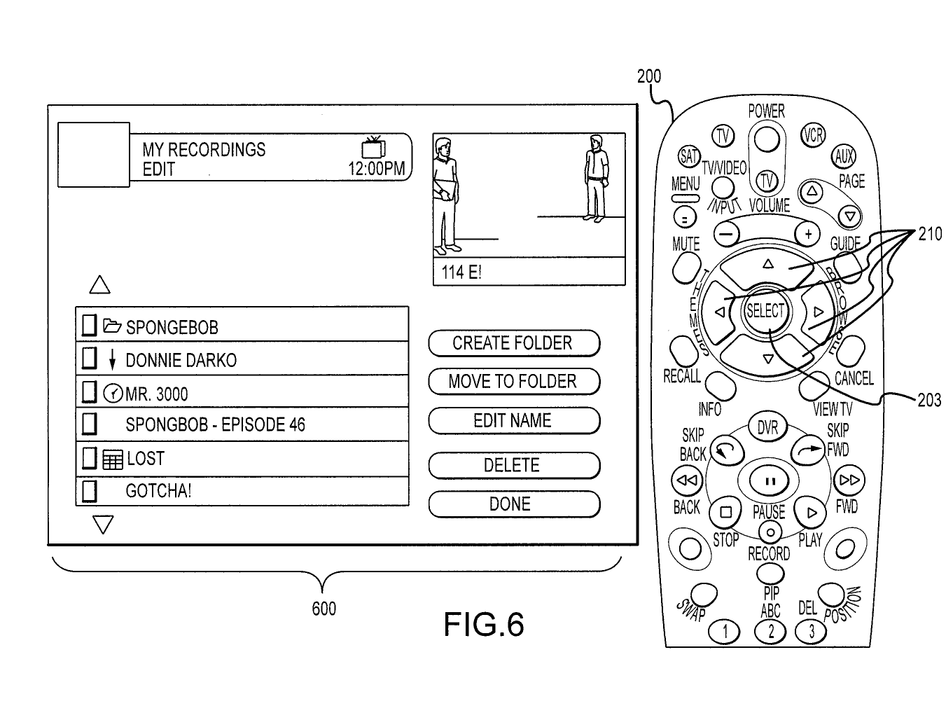

A digital video recording device (“DVR”) 130 is also provided, either as an integrated component of system 100 (as shown in FIG. 1) or as a separate component functionally coupled to system 100. DVR 130 generates and stores digital recordings of programs as selected by the user of system 100. The DVR 130 recordings may be scheduled, accessed, sorted, edited, and deleted via a user interface generated by GUI generator 103. Exemplary user interfaces that provide DVR options are illustrated in FIGS. 5-6 and described in further detail below.

The assembly of components of system 100 shown in FIG. 1 provides one example as to how system 100 may be implemented. The functionality of system 100 also may be implemented by alternative configurations and combinations of components as desired by the system implementer.

FIG. 1A provides a functional block diagram of functionality of the system 100 of FIG. 1. In FIG. 1A, the system 100 receives and stores all data necessary to perform the functions of the system (150). This data may include entertainment programs, program guide data, information about the entertainment programs, television broadcasts, program download data, movie and other entertainment channel transmissions, GUI display format data, customer service data, setup data, customer history and/or account data, and any other types of data. The received data may be stored in storage 102, or, in the case of television broadcasts and other real-time feeds from the remote communication system 140, the signals may be made available in real time on the user's display 105 as a conventional broadcast, cable, or satellite broadcast.

When a user turns on the display 105, the display defaults to a default display mode (151), for example, by displaying a real-time broadcast on the channel last selected by the user, by displaying an electronic program guide (EPG), or by displaying a default menu of entertainment options to the user (for example, “Main Menu” as illustrated in FIG. 3).

Upon receipt of input data from the user access device 120 (152), the receiver 104 transmits the input data to processor 110, which processes the input data (153) and directs the appropriate components of the system 100 to perform one or more functions based upon the contents of the input data from the user access device 120. The components of system 100 then carry out the requested function (154).

For example, the input data may constitute a request that the system 100 display certain information to the user or perform a specific function. A request may be, for example, a request for the system to change the channel displayed on the display 105; a request to play a recorded or downloaded program; a request to display the EPG; a request to display a menu of options, for example, relating to downloading of entertainment programs; or any other type of display requested by the input data from the user access device 120.

The input data may alternatively constitute a request wherein the user desires the system 100 to perform a specific function. Such function requests may include, for example, setup commands, search commands, downloading commands, requests for connection with customer support, and other types of commands.

In response to the request from the user access device 120, the processor 110 of system 100 carries out the function associated with the request in the input data from the user access device 120 (154). Each function may comprise a defined series of steps, e.g., stored in storage 102 and implemented under the control of processor 110, that the components of system 100 must perform to complete the requested function.

For example, upon receiving a display request, the system 100 displays the selected channel (by changing the channel to which the television is tuned), program (from a selection of stored or otherwise accessible programs), EPG (for example, as obtained by communication component 101 from the remote communication system 140), menu (generated by GUI generator 103) or other information requested by the input data.

In another example, in response to a search request, the processor 110 searches the data stored in storage 102 using the search criteria received from the user access device 120 and displays the search results to the user by providing them to the GUI generator 103, which generates search result display data for display 105, for example, using a predefined display format stored in storage 102 or in GUI generator 103.

In other examples, in response to a setup request, the processor 110 performs the associated changes to the system 100 setup. In response to a download request (for example, a program purchase or rental request), processor 110 directs communication component 101 to transmit a request for the selected download to the remote communication system 140, and, upon receiving the requested download from the remote communication system 140, to store the download to storage 102. In response to a request for customer service support, the processor 110 may enable communication between a customer support center and the system 100 to enable the user to obtain customer support functions.

After completing the selected request associated with the received input data from the user access device 120, processor 110 directs GUI generator 103 to generate result display data (155) confirming completion of the requested function (and/or status display data indicating the status of the command, such as download progress, and/or error data indicating that the command associated with the input data has not been completed).

In some instances, the result display data may prompt the user to enter subsequent input data via the user access device 120 (156), which is processed by the system 100 as described above with reference to functions 152-156.

Various types of display requests and function requests are described in further detail below with reference to FIGS. 3-12B.

FIG. 2 provides a diagram of an exemplary user access device 120 for use with system 100 in FIG. 1. Other configurations of user access devices may be used to access the functionality of the system, including user access devices 120 that receive and display data from the system 100. User access devices having buttons with different labels, different or combined functionality, and/or different arrangements than those shown in on remote 200 are also contemplated.

In FIG. 2, the user access device 200 is a wireless IR or RF universal remote control device that includes buttons to enable a user to perform functions relating to the television, VCR, satellite, and other auxiliary device, as well as access the functionality of the system 100.

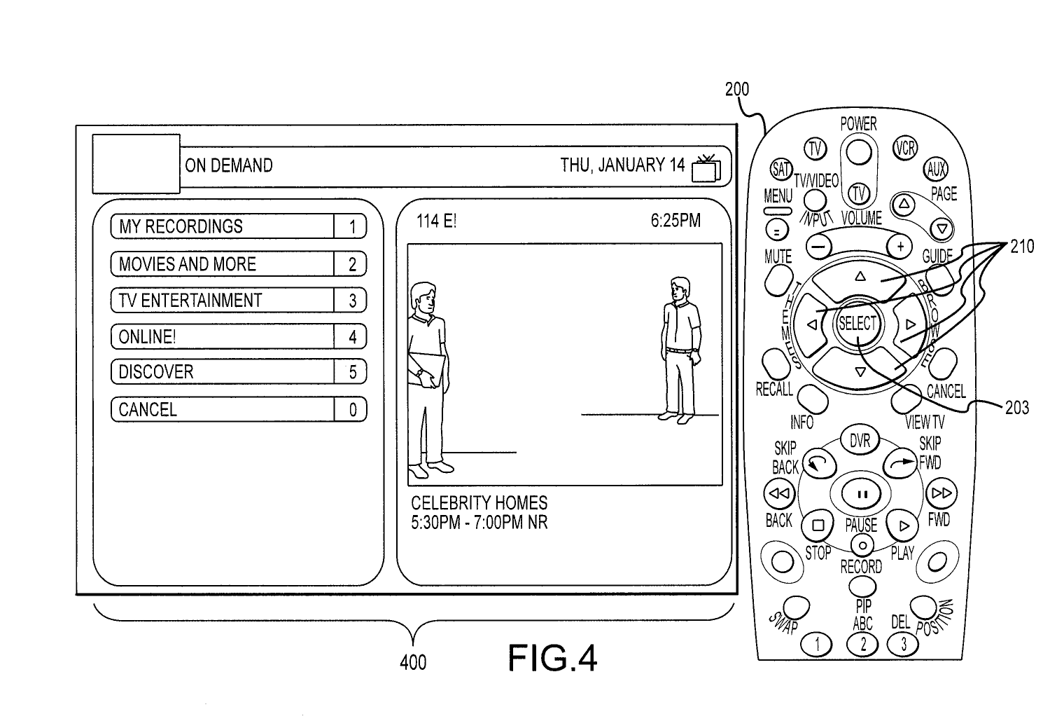

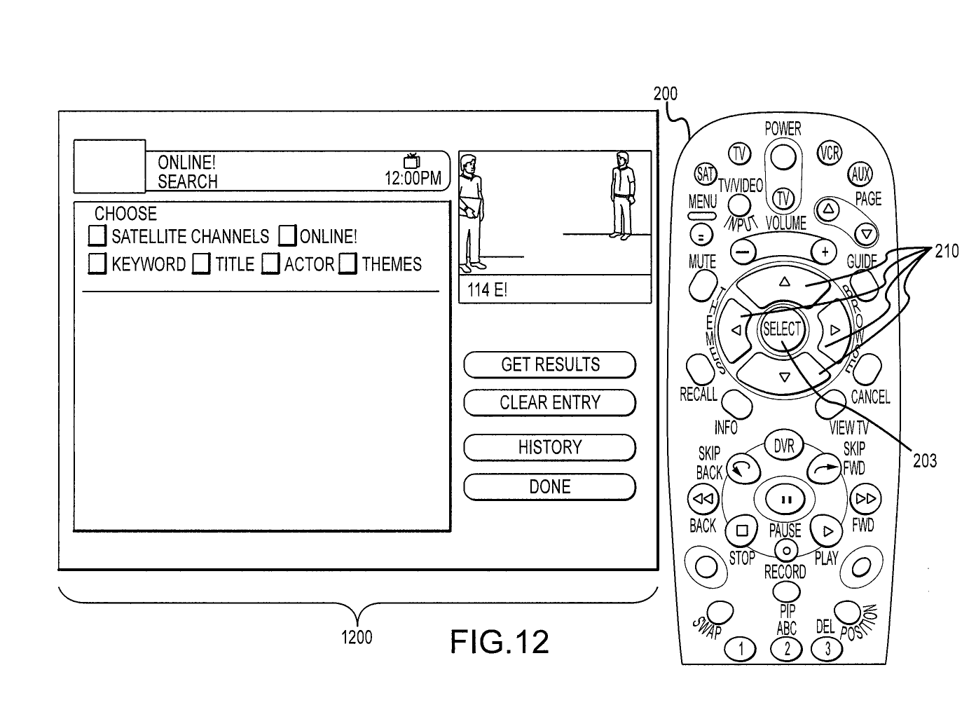

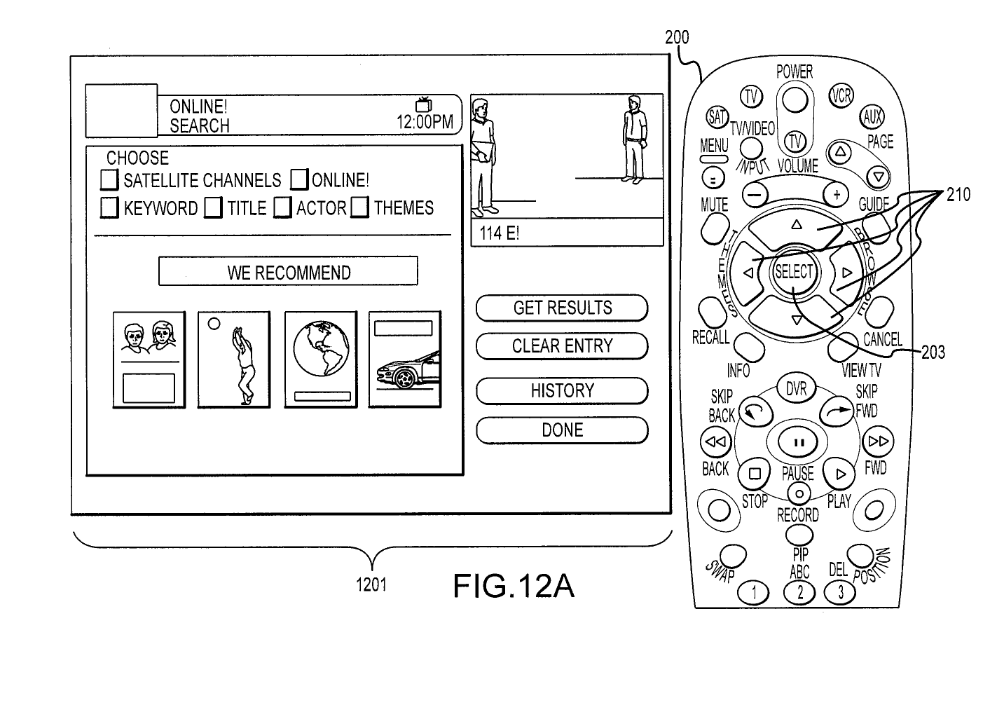

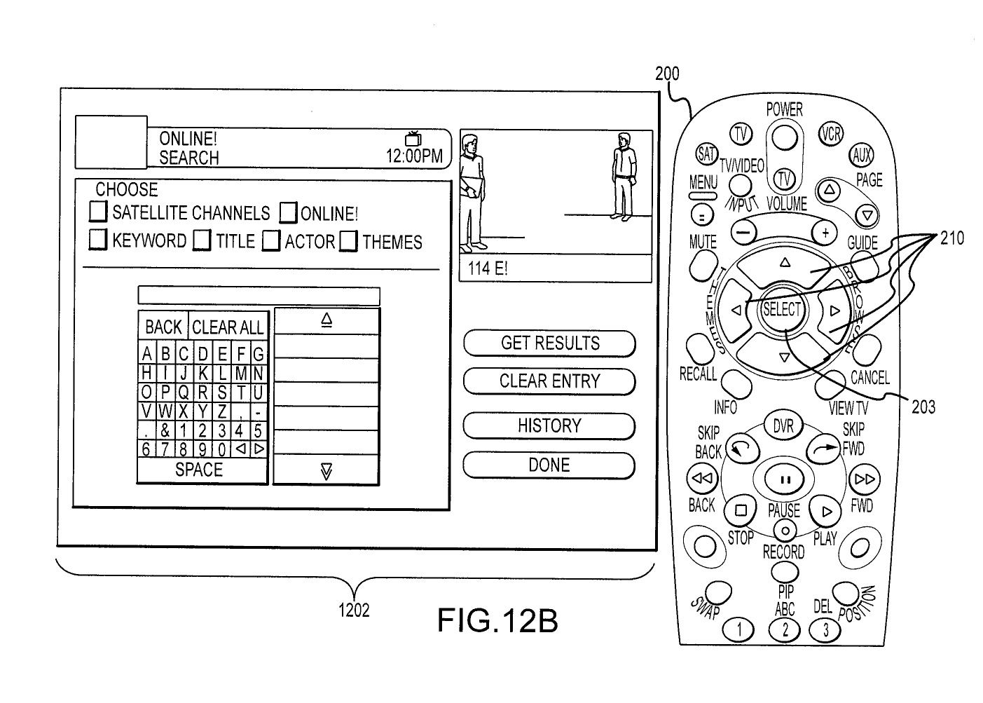

For example, a user may press button 201 “Guide,” which transmits display function input data to the system 100, instructing the system 100 to display an electronic guide or EPG. Similarly, the user may press the “DVR” button 202 to transmit display function input data to instruct the system to display “DISH on Demand” or “My Recordings” user interface screens, described in detail below with reference to FIGS. 4-5. A “Menu” button 204 may be provided to access the main menu of the system 100 user interface, for example, as shown in FIG. 3. A “Select” button 203 may also be provided. Additionally, a “Search” button (not shown) may be provided to enable the user to access searching functionality of the system 100 (described below in further detail with reference to FIGS. 12-12B). Arrow keys 210 may also be provided to enable the user to navigate the entertainment options displayed in the graphic user interfaces generated by the system 100.

FIG. 3 provides an exemplary “Main Menu” display that may be generated by GUI generator 103 of system 100. A user may access the “Main Menu” of the user interface of system 100 by pressing an associated function button on the user access device 120, for example, the “Menu” button 204 on remote 200. With reference to FIG. 1, when the receiver 104 receives the “Menu” input data from the user access device 120, the input data is provided to processor 110, which directs the GUI generator 103 to generate the “Main Menu” display data for display 105.

The “Main Menu” shown in FIG. 3 provides an exemplary graphic user interface by which the user may access a number of entertainment options, including “Program Guide” (to display the EPG), “Themes & Search,” “Customer Support,” “Multimedia,” “Locks,” “System Setup,” “Daily Schedule,” “Preferences,” “DISH on Demand,” and “Cancel” options. Each of these selections may be accessed by the user by using the arrow buttons and “Select” button 203 on remote 200. Additional or alternative options (or different names for similar options) may be included in the “Main Menu.”

If a user selects the “DISH on Demand” option from the “Main Menu” of FIG. 3, the “DISH on Demand” user interface menu appears as shown in FIG. 4. FIG. 4 depicts an exemplary graphic user interface 400 that enables a user to select from a number of entertainment options as described below. The menu options of the user interface are accessed by the user's manipulation of a user access device 120, such as remote 200 (shown on the right side of FIG. 4) on which the user manipulates the arrow buttons 210 and “Select” button 203 to select from the menu options displayed on the user's display.

The user interface menu display of FIG. 4 enables users to select from a plurality of entertainment options: “My Recordings,” “Movies and More,” “TV Entertainment,” “DISH Online,” “Discover DISH,” and “Cancel.” The “DISH on Demand” menu also or alternatively may be accessed by pressing a dedicated button on the user access device 120, for example, the “DVR” button 202 on remote 200 shown in FIG. 2.

In response to the user's selection of the “My Recordings” entertainment option, system 100 displays a user interface (e.g., 500 in FIG. 5) listing programs previously recorded by the user using the user's DVR, which may be implemented as an integral component 130 of system 100 as shown in FIG. 1, or as a separate component. The “My Recordings” option also or alternatively may be accessed by pressing a dedicated button (not shown) on the user access device 120. Additional details concerning the “My Recordings” option is provided below with reference to FIGS. 5, 5A, 5B, and 6.

Selection of the “Movies and More” entertainment option may provide access to a list of available on-demand programs, such as movies and other types of programs. On-demand programs may include programs that are automatically downloaded to system 100 from the remote communication system 140 and stored in storage 102. These on-demand programs are stored in storage 102 of system 100 for a predetermined period of time, as determined by the remote communication system 140. The user does not select which programs are provided as on-demand programs by the system 100. Thus, by accessing the “Movies and More” entertainment option, the user is presented with a user interface that enables the user to select one or more of the on-demand programs for viewing, for example, by paying a viewing fee (e.g., program rental or purchase fee) associated with the selected program(s). Once the user has completed the on-demand program selection (and payment) process, the user may view the selected program(s) immediately without the need to download the selected program(s) from the remote communication system 140.

Selection of the “TV Entertainment” entertainment option may provide access to a list of available on-demand television programs, such as previously-aired television programs. Like the on-demand programs discussed above, the on-demand television programs are programs that are automatically downloaded to system 100 from the remote communication system 140 and stored in storage 102 for a predetermined period of time determined by the remote communication system 140. The user does not select which television programs are provided as on-demand television programs by the system 100. Thus, by accessing the “TV Entertainment” entertainment option, the user is presented with a user interface that enables the user to select one or more of the on-demand television programs for viewing, for example, by paying a viewing fee (e.g., program rental or purchase fee) associated with the selected program(s). Once the user has completed the on-demand television program selection (and payment) process, the user may view the selected television program(s) immediately without the need to download the selected program(s) from the remote communication system 140.

Selection of the “DISH Online” entertainment option of the “DISH on Demand” in FIG. 4 enables the user to access downloading options concerning rental and purchase of programs, such as movies, games, etc., beyond those available as on-demand options. Additional details concerning the “DISH on Demand” selection are provided below with reference to FIGS. 4-12.

Selection of the “Discover DISH” option of the “DISH on Demand” of FIG. 4 enables the user to access content describing, for example, the system equipment, programs, services, as well as tutorials and videos that enable the user to learn about the system 100. For example, tutorials may be provided to instruct the user on how to record programs, how to set up a timer, how to manage the user's account, etc. This entertainment option may be implemented to provide any information desired by the user and/or system implementer.

Finally, selection of the “Cancel” option of the “DISH on Demand” in FIG. 4 returns the user to a previous menu, such as the “Main Menu” of FIG. 3, or to the program being shown on the user's display 105.

FIG. 5 depicts an exemplary user interface menu 500 entitled “My Recordings,” which is displayed when the user selects this option from the “DISH on Demand” menu of FIG. 4. The “My Recordings” user interface displays a listing of programs previously recorded by DVR 130. In the exemplary user interface 500, some of the previously recorded programs are organized in folders. For example, the “Spongebob” listing represents a folder containing 27 previously recorded episodes of the program “Spongebob.” A folder icon is provided to the left of the “Spongebob” listing to indicate that this is a folder, and not an individual program. The remainder of the programs shown in interface 500 are individual programs.

The user interface 500 provides several options from which the user may select. First, the user may select to watch one of the recorded programs or open a program folder to see a listing of individual recordings in the folder by highlighting the desired recording using arrow keys 210 and pressing the “Select” button 203 on remote 200. Additionally, user interface 500 provides the user with the following options: “Sort,” which enables the user to sort recordings based upon various sorting criteria, such as keyword, title, recording time and/or date, program theme (action, comedy, romance, horror, foreign, documentary, etc.), etc.; “Edit,” which is discussed in detail below with reference to FIG. 6; “Schedule,” which enables the user to view upcoming recordings and to schedule additional DVR recordings; “History,” which shows the user's recording history; and “Done,” which enables the user to exit the user interface 500 and, for example, return to a previous menu such as the “DISH on Demand” menu of FIG. 4 or to the program being shown in the user's display 105. Additional options may also be included as desired by the system implementer and/or user.

FIG. 5A depicts an exemplary user interface 501 that is generated by the system 100 when the user selects the “Spongebob” folder shown in interface 500 of FIG. 5. In interface 501, a listing of the individual recordings stored in the “Spongebob” folder (FIG. 5) is shown. Each of these individual recordings may be selected by the user through manipulation of the arrow keys 210 and “Select” button 203 on remote 200. The user may also select “Sort,” “Edit,” or “Done” options from interface 501. The “Sort” option enables the user to sort recordings based upon various sorting criteria, such as keyword, title, recording time and/or date, program theme, etc. The “Done” option enables the user to exit the user interface 501 and, for example, return to a previous menu such as the “My Recordings” menu of FIG. 5 or to the program being shown in the user's display 105. Additional options may also be included as desired by the system implementer and/or user. The options may be accessed, for example, by manipulating the arrow keys 210 and “Select” button 203 on remote 200.

If the user selects the “Edit” option in interface 501, a new user interface 502 as shown in FIG. 5B is displayed by the system 100. User edit options include “Edit Name,” “Delete” and “Done,” which are accessed, for example, by manipulating the arrow keys 210 and “Select” button 203 on remote 200. Additional options may also be included as desired by the system implementer and/or user.

FIG. 6 depicts an exemplary graphic user interface 600 of an editing menu provided by system 100 upon the user's selection of the “Edit” option in FIG. 5. Options provided by the user interface 600 include: “Create Folder,” which enables the user to create a folder in which to place recordings; “Move to Folder,” which enables the user to move a recording to a selected folder; “Edit Name,” which enables the user to edit the names of folders or recordings; “Delete,” which enables the user to delete recordings and folders; and “Done,” which enables the user to exit the user interface 600 and, for example, return to a previous menu such as the “My Recordings” menu of FIG. 5 or to the program being shown in the user's display 105. Additional options may also be included as desired by the system implementer and/or user. For example, an “Protect” option (not shown) may enable the user to lock access to selected programs such that only a person with the password or access code to the lock is able to access the program, thereby providing a method of limiting access to one or more programs. The user options may be accessed, for example, by manipulating the arrow keys 210 and “Select” button 203 on remote 200.

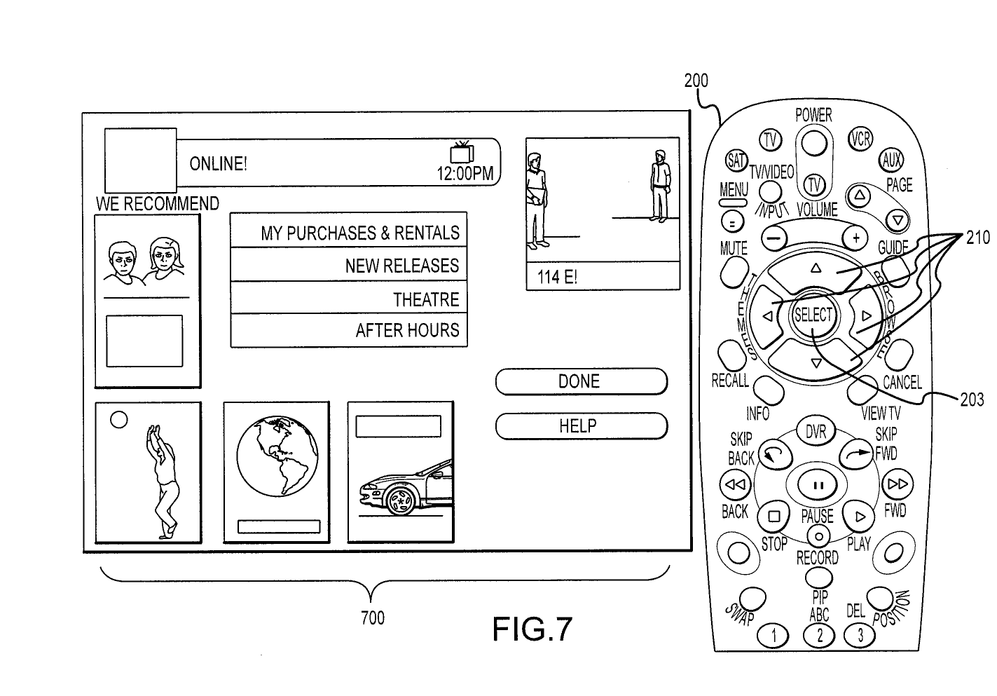

Upon selection of the “DISH Online” entertainment option depicted in the user interface 400 of FIG. 4, a user interface generated by system 100 is displayed, such ash the exemplary user interface 700 depicted in FIG. 7. This interface 700 enables a user to select from a number of entertainment options, including “My Purchases & Rentals,” “New Releases,” “DISH Theatre” and “After Hours.” Each of these options is described below in detail. The options may be accessed, for example, by manipulating the arrow keys 210 and “Select” button 203 on remote 200. Additional or alternative options (or different names for similar options) may be included in the “DISH Online” menu.

In addition, the interface 700 displays a number of recommendations to the user, entitled “We Recommend.” The user may select one of more of these recommended programs, for example, by manipulating the arrow keys 210 and “Select” button 203 on remote 200. Upon selection of a recommended program using the “Select” button 203, details about the recommended program as well as rental and purchase options may be displayed to enable the user to read more about the recommended program and to either rent or purchase the program.

Recommendations for each user may be generated in a number of ways as desired by the implementer of the system and/or the user. For example, recommendations may be generated based upon the user's program recording and/or rental history and/or viewing habits, which may be stored as user history data in storage 102. The user's history may, for example, suggest that the user likes a certain actor, a certain director, and/or a certain genre or theme of programs (comedy, action, horror, drama, etc.). This information may be used to identify other programs having the same or similar characteristics, which are then displayed as recommendations to the user.

Alternatively or additionally, recommendations may be generated based upon information not related to the individual user. For example, recommendations may be popular rental or purchased programs, new releases, etc.

With reference to FIG. 7, the user interface provides a “Help” option to the user that enables the user to access information about “DISH Online” and may provide contact information in the event the user desires to access customer support services. The “Done” option enables the user to exit the user interface 700 and, for example, return to a previous menu such as the “DISH on Demand” menu of FIG. 4 or to the program being shown in the user's display 105.

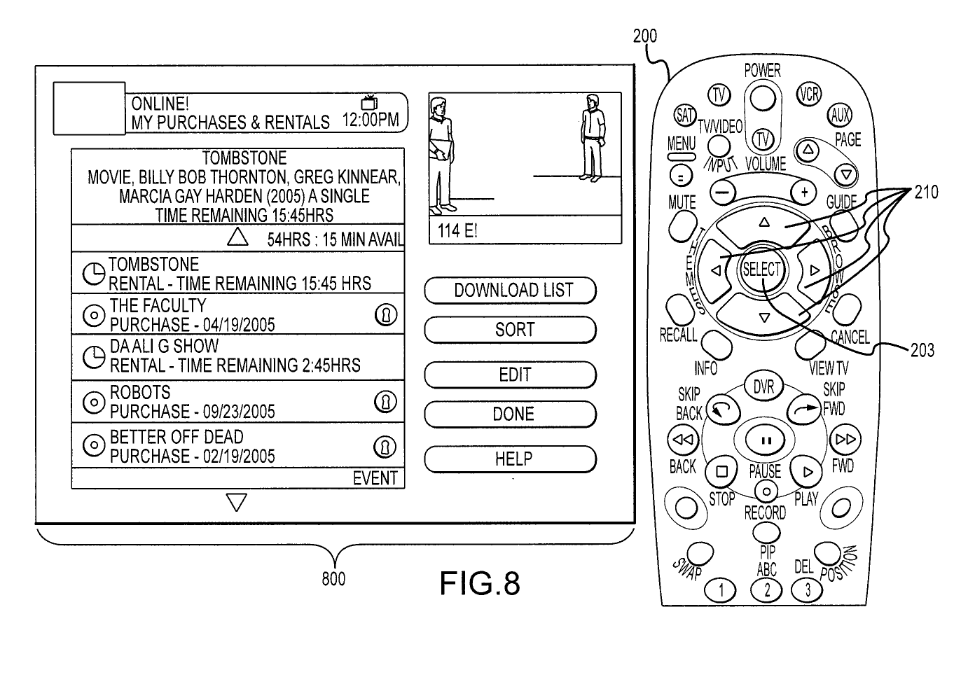

Upon selection of the “My Purchases & Rentals” entertainment option from user interface 700, system 100 may display, for example, user interface 800 as depicted in FIG. 8. This interface 800 displays a list of the programs that have been previously purchased and rented by the user. This list may include on-demand programs rented or purchased as described above with reference to FIG. 3. For purchased programs, the status “Purchase” may be shown with the purchase date. For rented programs, the status “Rental” may be displayed along with the rental time remaining. As the user scrolls through the list of programs, for example, using arrow keys 210 on remote 200, for each highlighted program the system 100 may display information about the program, for example, the program theme (movie, documentary, etc.), the actors starring in the program, the date of release of the program, and/or a brief description of the contents of the program. This feature is depicted in interface 800, wherein the program “Tombstone” is highlighted and information about the movie is displayed above the highlighted movie on the display screen.

Additional information may also be conveyed to the user by interface 800. For example, rental programs for which there is only a short time remaining may be highlighted or displayed in a manner to indicate the short remaining rental time, for example, by displaying the program in red, by having the listing flash, or by any other method to draw the user's attention to the program. Additionally or alternatively, the system 100 may display all programs having a defined period of rental time or less remaining at the top of the user's list of purchased and rented programs. The system 100 may also provide an option to enable the user to renew a program rental or purchase a rented program.

User interface 800 in FIG. 8 provides a number of options to the user, including “Sort,” “Edit”, “Done” and “Help,” which enable the user to access functionality similar to that described with reference to interface options of the same name described above. Notably, the program locking functionality described with reference to the “Protect” option in interface 600 may be implemented to limit access to selected programs, as indicated in interface 800 by the key icon displayed to the right of several programs.

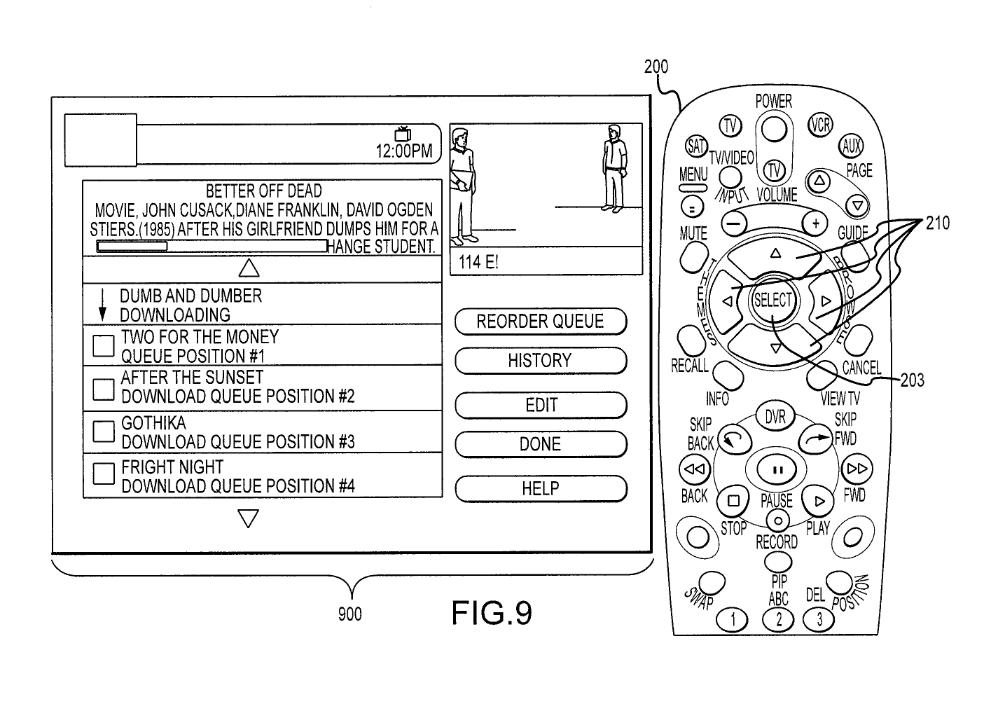

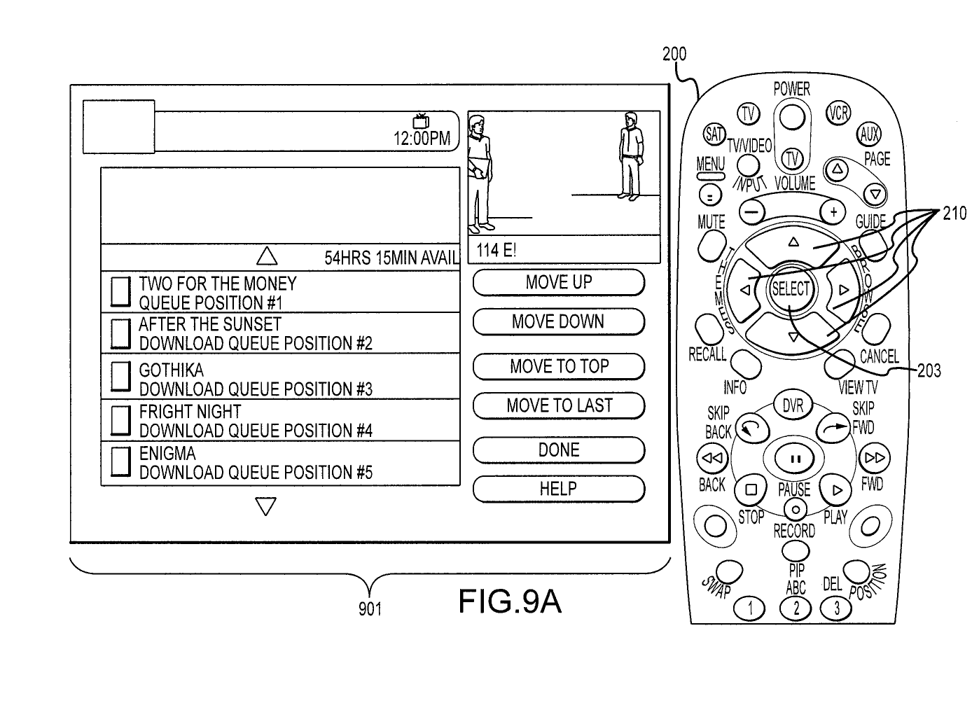

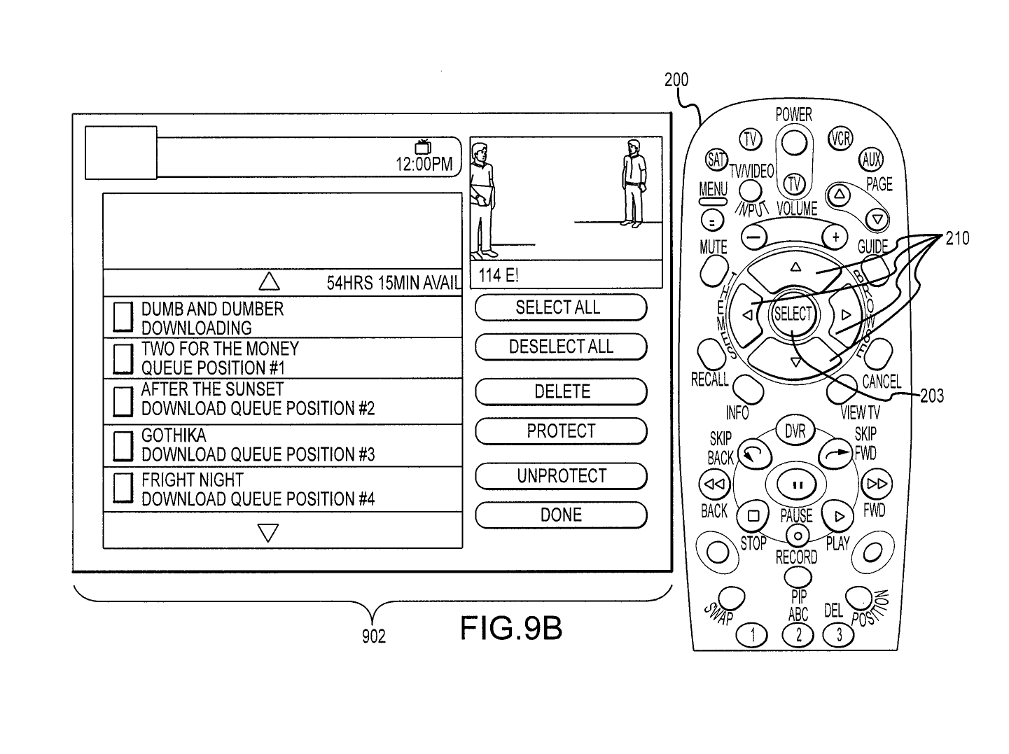

Upon selection of the “Download List” option of interface 800, the system generates a user interface such as that shown in FIG. 9. Interface 900 provides a list of downloads to be performed by system 100 from the remote communication system 140. As shown in FIG. 9, the program “Better Off Dead” is in the process of being downloaded, and the horizontal bar indicates the progress of the downloading process. Additional programs to be downloaded are listed under the downloading program. The user may select the “Reorder Queue” option to change the order of scheduled downloads, view previous downloading history by selecting the “History” option, edit the download list by selecting the “Edit” option, or select “Done” or “Help” options (as described above). Also, by highlighting or selecting a program in the queue, the user may view estimated downloading time. The options may be accessed, for example, by manipulating the arrow keys 210 and “Select” button 203 on remote 200.

FIG. 9A depicts an exemplary user interface 901 that may be displayed by the system 100 when the user selects the “Reorder Queue” option in interface 900. As shown in interface 901, for any selected program in the download queue, the user may select to move the program up in the queue (“Move Up”), move the program down in the queue (“Move Down”), or move the program to the top or bottom of the queue (“Move to Top” and “Move to Last” respectively). “Done” or “Help” options (as described above with reference to different user interfaces) are also provided.

FIG. 9B depicts an exemplary user interface 902 that may be displayed by system 100 when the user selects the “Edit” option from interface 900 shown in FIG. 9. “Edit” options include “Select All,” “Deselect All,” “Delete,” “Protect,” “Unprotect” and “Done.” The “Protect” option may enable the user to limit access to selected programs such that only a person with the password or access code is able to access the program, thereby providing a method of limiting access to one or more programs. The “Unprotect” option may enable the user to remove password protection from selected programs.

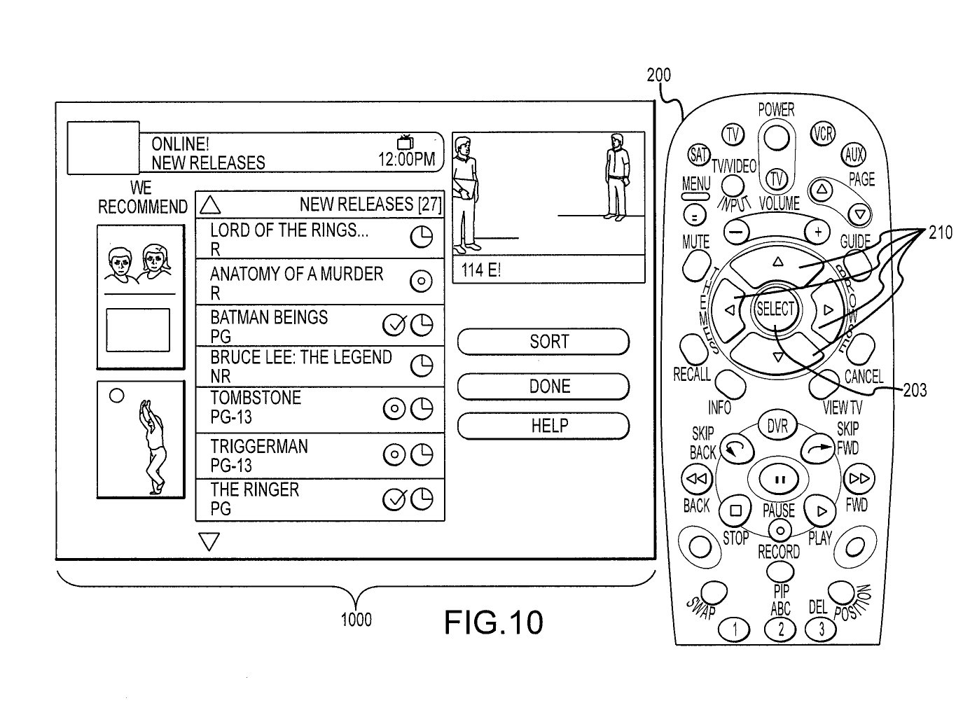

With reference to FIG. 7, upon selection of the “New Releases” entertainment option in interface 700, system 100 may display an interface such as interface 1000 shown in FIG. 10. Interface 1000 provides a list of new release programs that are available for rental or purchase as downloads from the remote communication system 140. Recommendations are also provided, as discussed above with reference to FIG. 7. The user may select any of the listed new release programs or recommendations by highlighting the program, or may select to “Sort” the listing of available new release programs based upon various sorting criteria, such as title, recording time and/or date, program theme, etc. “Done” or “Help” options (as described above) are also provided.

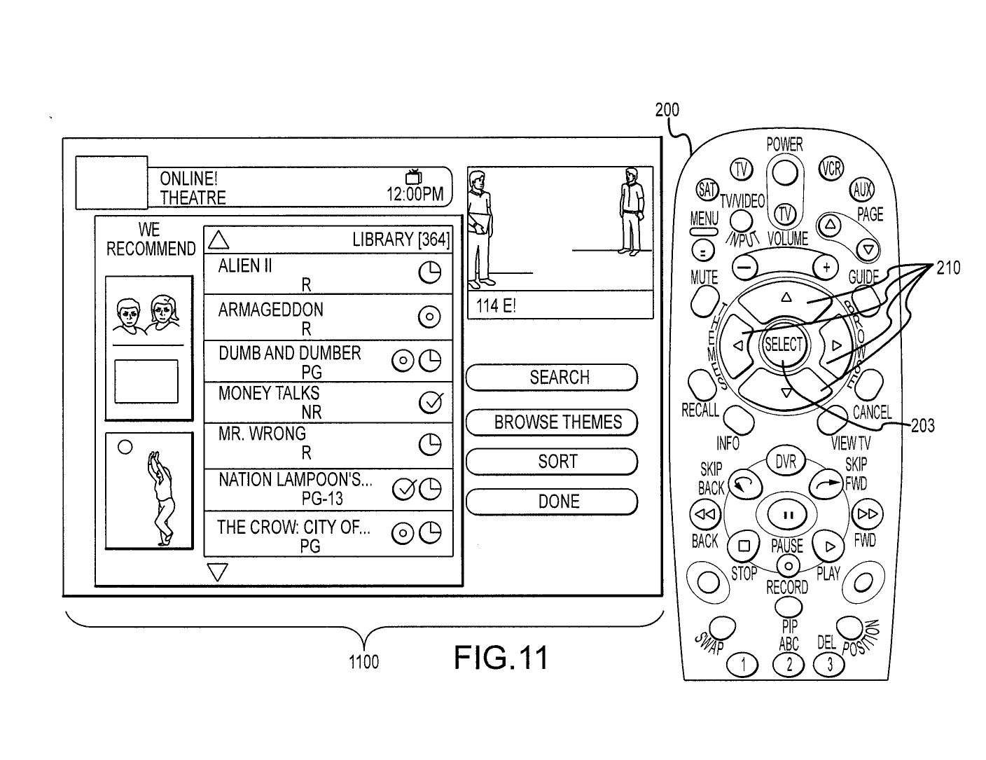

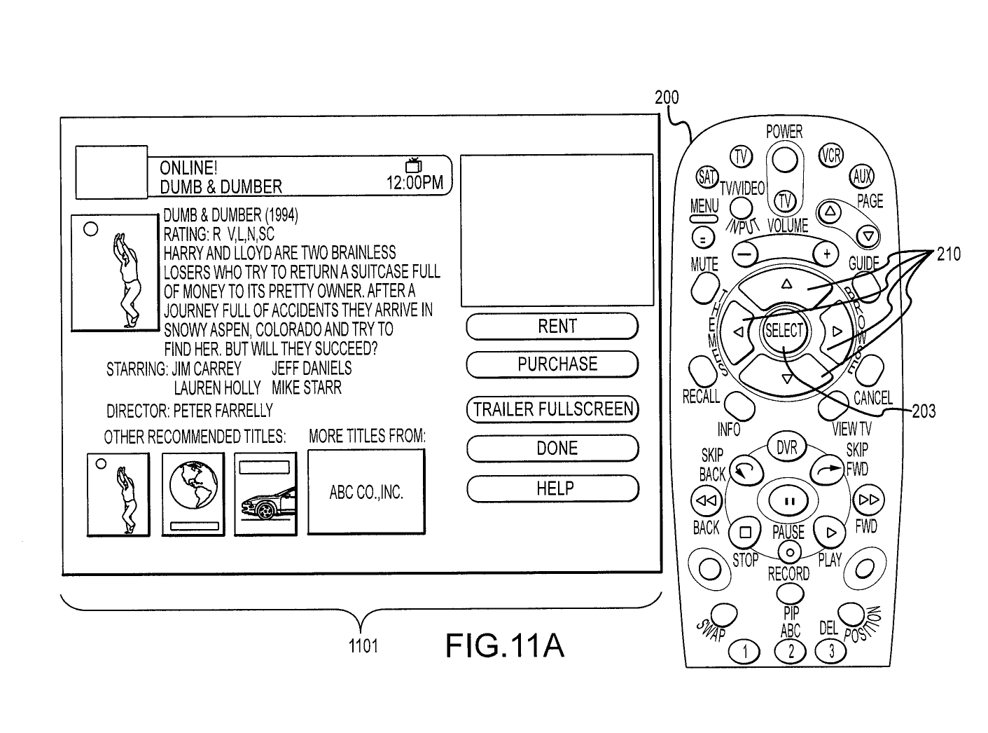

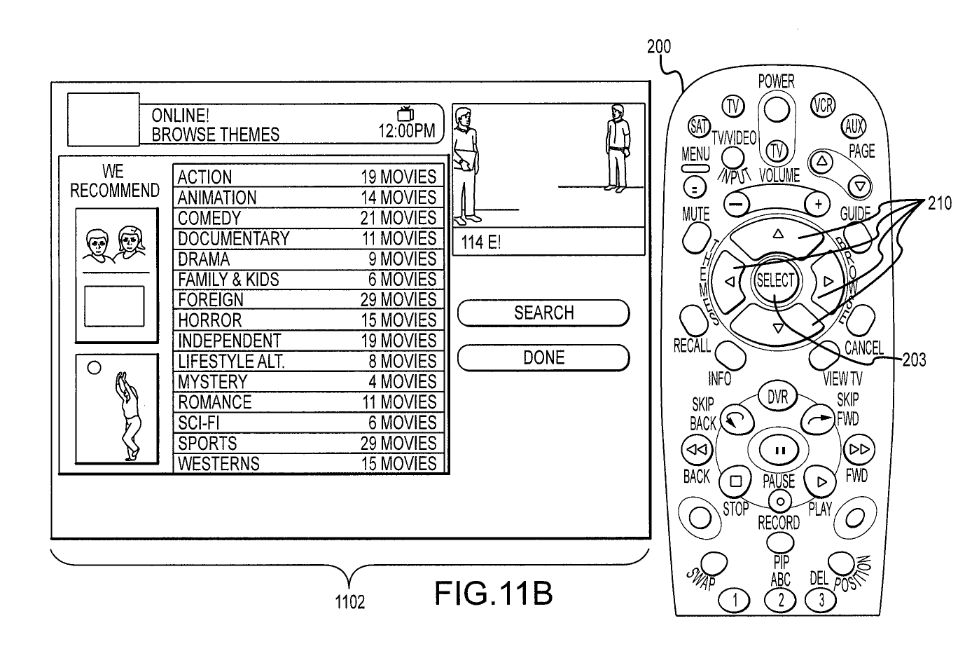

With reference to FIG. 7, upon selection of the “DISH Theatre” entertainment option in interface 700, system 100 may display an interface such as interface 1100 shown in FIG. 11. Interface 1100 provides a list of all programs that are available for rental or purchase as downloads from the remote communication system 140. Recommendations are also provided, as discussed above with reference to FIG. 7. The user may select any of the listed programs or recommendations by highlighting the program, search the program listing using the “Search” option (see FIG. 12) or select the “Browse Themes” options that enables the user to see a subset of the available programs, for example, based upon the type or genre of program (action, adventure, comedy, romance, foreign, documentary, mystery, horror, etc.), an example of which is shown in user interface 1102 in FIG. 11B. Also, the user may select to “Sort” the listing of available new release programs based upon various sorting criteria, such as title, recording time and/or date, program theme, etc. “Done” or “Help” options (as described above) are also provided.

An exemplary user interface 1101 that may be displayed when the user selects a program from the list displayed in either interface 1000 or 1100 is shown in FIG. 11A. Interface 1101 provides “Rent,” “Purchase,” “Trailer Fullscreen” (to access the trailer for the movie), “Done,” and “Help” options that may be selected by the user, for example, using remote 200.

Upon selection of the “Rent” or “Purchase” option, the system 100 may display pricing information, time limits for rental programs (e.g., 24 or 48 hours), estimated download time for the program, and other information. For example, the interface may advise the user that the rental time period begins at the start of the first viewing of the program.

The new release programs accessed using the “New Releases” option in interface 700 may be implemented as a subset of the program library available in the “DISH Theatre” option.

An exemplary user interface 1200 generated by system 100 that enables the user to access searching functionality for the list of programs available for rental and/or purchase is shown in FIG. 12. In user interface 1200, the user may select to search satellite channels and/or DISH Online listings by keyword, title, actor, and/or themes. Additional search options may also be provided as desired by the system implementer and/or user.

An exemplary search process will now be described in detail with reference to user interface 1200, 1201, an 1202 (FIGS. 12, 12A, and 12B). When the user selects “DISH Online” for searching, the system 100 may display user interface 1201 (FIG. 12A), in which recommendations are displayed to the user (as described above with reference to FIG. 7). Upon selection of a type of search (e.g., keyword, title, actor, themes), a keyboard may be displayed as shown in interface 1202 (FIG. 12B) to enable the user to enter one or more words, for example, by using the arrow keys 210 and “Select” button 203 on remote 200. Upon entry of a letter, system 100 may display a listing of suggested keywords, program titles, actors, and/or themes beginning with the letter selected by the user to assist the user in searching.

After selecting the desired search options shown in interfaces 1200-1202, the user then selects the “Get Results” option (or the “Clear Entry” option to start over). The user may also access search history using the “History” option or return to the previous menu or current program by selecting “Done.”

With reference to interface 700 in FIG. 7, an “After Hours” or comparable entertainment option may be provided for adult entertainment options. Such options may be password protected by the user to limit access to the adult programming options. Moreover, a waiver or disclaimer may also be provided prior to enabling user access to the adult programming options to insure that users accessing the programs are 18 or older (legal adults). The programs provided in the “After Hours” option of user interface 700 may be implemented as a program library that is stored and accessed separately from the program library available through the “DISH Theatre” option of user interface 700. The adult programs also may be offered as a separate service option from the remote communication system 140.

The entertainment options illustrated as selections in the user interface menu options in FIGS. 3-12B additionally or alternatively may be accessed by pressing a dedicated button (not shown) on the user access device 120 or via any means desired by the implementer of the system to enable user access to the entertainment options provided by system 100.

The exemplary graphic user interfaces described above with reference to FIGS. 3-12B are intended to provide examples of interfaces that may be used to provide the functionality of system 100 and are not intended to limit the many possible implementations of system 100. The functionality and features of the system 100 alternatively may be implemented in any number of different graphic user interfaces. Additional and/or alternative options or features may also be included. Moreover, the options and features described above may be implemented using different graphic user interfaces, menu selection displays, option labels or names, etc.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A system for accessing entertainment options, comprising:
a communication component for transmitting and receiving program data to and from a remote communication system;
a graphic user interface generator for generating display data to be displayed on an associated display device, the display data generated at least partially based on a user history; and
a receiver for receiving input data from a user access device;
wherein the program data includes a listing of programs available for downloading to the system from the remote communication system via the communication component;
wherein the graphic user interface generator generates program listing display data to display the listing of programs available for downloading to a user on the associated display device; and
wherein the user may select one or more programs from the listing displayed on the associated display device using the user access device, thereby initiating download of the selected program by the communication component.

2. The system of claim 1, further comprising a storage device for storing the program data and the user history data.

3. The system of claim 2, further comprising a processor operative to generate recommendation data based upon the stored user history data.

4. The system of claim 3, wherein the graphic user interface generator generates recommendation display data based upon the recommendation data to enable the user to view recommended program.

5. The system of claim 4, wherein the selected program may be selected by the user for downloading using the user access device.

6. The system of claim 4, wherein the downloaded programs may be rented such that the selected program download is available for viewing by the user for a predetermined period of time or purchased such that the selected program download is available for viewing by the user for an unlimited period of time.

7. The system of claim 6, wherein the graphic user interface generator generates rental time display data indicating the amount of viewing time remaining for each rented program download.

8. The system of claim 6, wherein the system displays an estimated download time for each available program.

9. A system for accessing entertainment options, comprising:
a communication component for transmitting and receiving program data to and from a remote communication system;
a storage device for storing the program data;
a processor;
a graphic user interface generator for generating display data to be displayed on an associated display device; and
a receiver for receiving input data from a user access device;
wherein the program data includes a listing of programs available for downloading to the system from the remote communication system via the communication component;
wherein the graphic user interface generator generates program listing display data to display the listing of programs available for downloading to a user on the associated display device;
wherein the user may select one or more programs from the listing displayed on the associated display device using the user access device, thereby initiating download of the selected program by the communication component; and
wherein the graphic user interface generator generates download queue data for display on the associated display device, the displayed download queue data enabling the user to view a current download status of each program to be downloaded.

10. The system of claim 9, wherein the user can change a download queue order of one or more programs to be downloaded using the user access device.

11. The system of claim 9, wherein the selected programs may be rented such that the selected program download is available for viewing by the user for a predetermined period of time or purchased such that the selected program download is available for viewing by the user for an unlimited period of time.

12. A method for accessing entertainment options, comprising:
receiving program data from a remote communication system, the program data comprising a listing of programs available for access;
storing the program data;
generating display data to be displayed on an associated display device, the display data associated with the program data;
receiving input data from a user access device;
generating program listing display data to display the listing of programs available for access on the associated display device;
receiving an indication that at least one program has been selected from the listing of programs available for access;
in response to receiving the indication, initiating download of the selected program.

13. The method of claim 12, wherein the remote communication system is the Internet.

14. The method of claim 13, wherein the user access device is a wireless remote control.

15. The method of claim 13, wherein the method is executed by a digital video recording device connected to the Internet.

16. The method of claim 12, wherein:
the remote communication system is a satellite broadcast system; and
the method is executed by a digital video recording device connected to the satellite broadcast system.

17. A system for accessing entertainment options, comprising:
a communication component for transmitting and receiving program data to and from a remote communication system, the program data including real-time programs broadcast by the remote communication system, program guide data including current and future broadcast program information, and download program data including programs available for download from the remote communication system;
a storage device for storing the program guide data and the download program data;
a graphic user interface generator for generating display data to be displayed on an associated display device; and
a receiver for receiving input data from a user access device;
wherein the program data includes a listing of programs available for downloading to the system from the remote communication system via the communication component; and
wherein a user may search the stored download program data or program guide data by entering one or more search criteria using the user access device.

18. The system of claim 17, wherein the user may enter a keyword, actor name, program title, or program theme as a search criterion.

19. The system of claim 17, wherein:
the remote communication system is the Internet;
the receiver is a digital video recording device; and
the display device is a television.

20. The system of claim 17, wherein the one or more search criteria is at least one metadatum associated with at least one entertainment option.
